(19) United States
(12) Patent Application Publication
(10) Pub. No.: US 2002/0184557 A1
(43) Pub. Date: Dec. 5, 2002

(54) System and method for memory segment relocation

(76) Inventors: Brian William Hughes, Fort Collins, CO (US); J. Michael Hill, Ft Collins, CO (US); Warren Kurt Howlett, Windsor, CO (US)

Correspondence Address: HEWLETT-PACKARD COMPANY, Intellectual Property Administration, P.O. Box 272400, Fort Collins, CO, 80527-2400, US

(21) Appl. No.: 09/842,435

(22) Filed: Apr. 25, 2001

(51) Int. Cl. G06F 11/20

(52) U.S. Cl. 714/8

(57) ABSTRACT

The present invention is directed to a system and method of evaluating the reliability of a memory segment wherein this method comprises the steps of counting malfunctioning elements in at least one instance of a defined geometric pattern of the memory segment, declaring a fault condition within the memory segment if a number of counted malfunctioning elements at least equals a fault threshold, and re-mapping the memory segment in response to a declared fault condition.

### RELATED APPLICATIONS

The present application is related to concurrently filed, commonly assigned, and co-pending U.S. patent application Ser. No. [Attorney Docket No. 10004547-1], entitled “DEVICE TO INHIBIT DUPLICATE CACHE REPAIRS”, the disclosure of which is hereby incorporated herein by reference.

### TECHNICAL FIELD

The present invention relates in general to computer hardware and in particular to a system and method for computer system error detection.

### BACKGROUND

In the field of computer hardware, it is generally desirable to test arrays of storage and/or processing elements to identify malfunctioning elements. Malfunctioning elements are generally identified by comparing data contained in such elements to an appropriate data template. If one or more malfunctioning elements are identified, appropriate substitution of new hardware locations for the malfunctioning elements is generally implemented.

One prior art approach involves employing hardware to store a bitmap of an array or other hardware architecture being examined. This bitmap generally catalogues locations, possibly by row and column number, of elements containing erroneous data within the array. A corrective operation may then substitute nearby areas on a chip for malfunctioning elements, or for contiguous sequences of elements which include malfunctioning elements. Generally, the bitmap includes data sufficient to describe an entirety of an array or other data processing architecture under test, thereby generally requiring a substantial amount of space on a silicon chip.

One problem associated with the bitmap approach is that considerable silicon area is generally needed to store data sufficient to fully identify the state of an array. In addition, the data processing resources required to process the bitmap and identify an optimal repair strategy generally demand complex on-chip circuitry. The bitmap approach may be implemented off-chip using an external tester having a separate microprocessor. However, when employing such an off-chip solution, a full repair will generally be required at the time the chip is tested. In addition, when using the bitmap approach, both the row and column of a malfunctioning element have to be known for a memory segment repair to be effectively conducted.

Therefore, it is a problem in the art that the bitmap diagnostic approach generally requires allocating a considerable amount of chip space for bitmap storage and processing.

It is a further problem in the art that the data processing resources associated with the bitmap approach generally demand complex circuitry, if implemented on-chip.

### SUMMARY OF THE INVENTION

The present invention is directed to a system and method of evaluating the reliability of a memory segment wherein this method comprises the steps of counting malfunctioning elements in at least one instance of a defined geometric pattern of the memory segment, declaring a fault condition within the memory segment if a number of counted malfunctioning elements at least equals a fault threshold, and re-mapping the memory segment in response to a declared fault condition.

### BRIEF DESCRIPTION OF THE DRAWING

FIG. 1 depicts a top view of a random access memory (RAM) array suitable for error detection according to a preferred embodiment of the present invention;

FIG. 2 depicts a flowchart which includes method steps for counting faulty data storage elements in an array according to a preferred embodiment of the present invention;

FIG. 3 is a block diagram of hardware suitable for implementing a conditional reset mechanism according to a preferred embodiment of the present invention;

FIG. 4 is a block diagram of hardware suitable for cache segment replacement according to a preferred embodiment of the present invention; and

FIG. 5 is a block diagram of computer apparatus adaptable for use with a preferred embodiment of the present invention.

### DETAILED DESCRIPTION

The present invention is directed to a system and method which identifies and counts computer hardware device element failures occurring in a particular region of memory or other computer component. The inventive mechanism preferably establishes a threshold number of errors for selected region below which the selected region is left unmodified by the mechanism of the present invention. However, where the number of errors meets or exceeds this threshold, which is preferably adjustable, corrective action is preferably taken with respect to the memory region as a whole. Of particular concern in the instant application, are errors occurring in a particular geometric pattern, such as within one column of a memory segment or region.

In a preferred embodiment, the inventive mechanism examines elements in a memory element array, which may be a cache region or cache memory region, or other type of array, employing a restricted array traversal order. Preferably, the traversal is performed so as to test all elements in a particular column within an array under test before moving on to elements in a succeeding column. Such a traversal is generally referred to herein as a “row-fast order traversal” or as a “row-fast traversal.” The inventive mechanism preferably establishes a threshold number of faulty elements which can be present in a particular column. When this threshold is met or exceeded, the inventive mechanism preferably identifies the entire array as faulty and takes appropriate corrective action. Preferably, corrective action involves substituting an alternative area of silicon on the affected chip for area originally used for the affected memory segment. Generally, a memory region which meets the threshold number of faults within a single column is interpreted as being sufficiently flawed to warrant discontinuing use of the array as a whole. In this manner, the inventive approach preferably obviates a need to save data reflecting the results of fault detection in a succession of columns located within the same array as a column already identified as faulty.

Generally, where there are faulty elements dispersed throughout an array but which are not present in sufficient number within any one column to trigger a determination that an entire array is faulty according to the present invention, a less extensive cure may be practiced. For example, row replacement may be practiced on rows of an array having one or more faulty elements. Note that true column failures may be detected instead of erroneously equating the existence of a selection of dispersed failures in disparate locations to a column failure. Also, bitmap hardware may be omitted, thereby operating to simplify the design of diagnostic circuitry and economizes on silicon real estate.

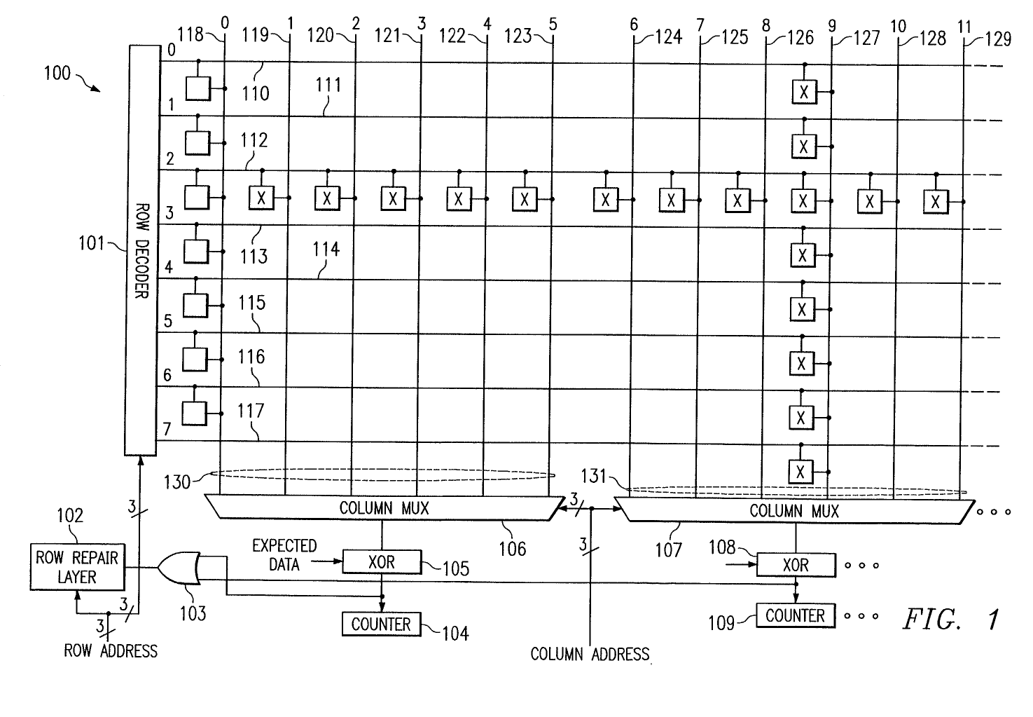

FIG. 1 is a diagram of a subset of a RAM array 100 suitable for testing an array employing a preferred embodiment of the present invention. The lower left portion of FIG. 1 shows the repair logic, including row repair layer block 102. Included in FIG. 1 is an array of data storage elements organized into rows 0 through 7, having reference numerals 110 through 117, respectively, a first group of columns 0-5, having reference numerals 118-123, respectively, and a second group of columns 6-11 having reference numerals 124-129, respectively. Generally, each unique combination of row and column number identifies one data storage element. The first group of columns, defining a first cache region 130, having six columns and eight rows, generally includes forty-eight data storage elements. A second cache region 131 is defined by rows 0 through 7 and columns 6 through 11. Where the device concerned is other than a cache memory region, the individual elements may be other than data storage elements. For example, in a microprocessor, elements of an array may be processing elements.

In a preferred embodiment, an address is provided to array 100 that is processed by row decoder 101. Preferably, a row address will be sent to row decoder 101 which will decode the address and drive one of the horizontal lines, or “word lines” across array 100. Preferably, when a word line fires across the array, all of the cells in that row are accessed and drive data onto the bit lines which are the vertical lines in the diagram. Six values will generally be presented to column muxes 106 and 107 at the bottom of array 100.

Herein, the group of columns 0-5, represented by reference numerals 118-123, respectively, is referred to as cache region 1 130. Once a column is identified, specifying the row number for a data storage element uniquely identifies a data storage element within array 100 to column mux (multiplexor) 106.

In a preferred embodiment, when testing the data storage elements, the inventive mechanism writes data into array 100, thereby placing individual data storage elements into an expected state. This stored data is later read out of array 100 and compared to an appropriate data template to determine whether the data stored in the element still holds the expected value. If the comparison indicates that the storage element under test does not hold the expected value, this comparison failure is interpreted as an indication of a hardware failure in the pertinent data storage element. The number of occurrences of faulty data storage elements is preferably counted to keep track of an extent of failure occurring within a particular cache segment or memory segment. A range of remedial measures may be available depending upon the extent of failure of data storage elements within a particular cache region.

In a preferred embodiment, XOR (Exclusive-Or) gate 105 receives data from a column within array 100, compares the retrieved data with an expected value for the data and indicates whether the comparison succeeds or fails. If the comparison fails, counter 104 adds the failure to a running count of failures.

In a preferred embodiment, numerous options exist for repairing an array when one or more faults are detected therein. One approach involves using an alternative physical region on a silicon chip for an entire cache segment such as cache segment 130. A less drastic corrective measure generally involves replacing selected rows within a cache region, where only selected rows are found to contain faulty data storage elements.

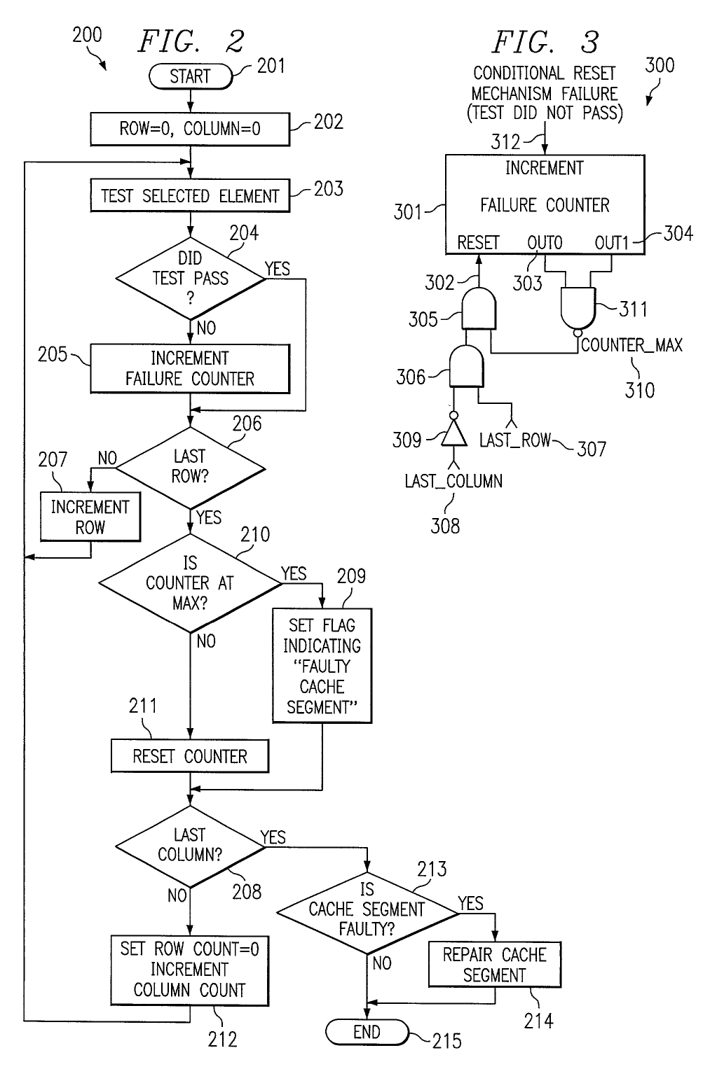

FIG. 2 depicts a flowchart which includes method steps for counting faulty data storage elements in an array according to a preferred embodiment of the present invention. In general, the instant approach involves determining whether any one column within cache segments 130 or 131 meets or surpasses a threshold number of faulty data storage elements. Where such threshold is met or exceeded, the cache segment or memory segment including such column is preferably flagged as being faulty. Preferably, the operations described in the flowchart of FIG. 2 may be practiced on two or more cache regions at the same time, employing parallel hardware, such hardware including XOR gates, counters, such as counter 104, and sources of expected data. The following discussion, however, is directed toward the operation of the present invention on a single cache region.

In a preferred embodiment, the inventive method starts at step 201. At step 202, the inventive method sets the row and column counters to 0. Where a plurality of counters are employed, a group of different initialization values for the column count would generally be employed. At step 203, the element designated by the current row and column count is preferably tested by comparing the data stored therein to a value expected for that element. Preferably, if the element fails the test, decision block 204 directs execution to step 205, where the failure count for the current column is incremented. If the element passes the test, execution is preferably directed so as to skip incrementing step 205.

In a preferred embodiment, at step 206, the inventive mechanism determines whether the current row count identifies the last row in the array. If the current row is the last row in array 100, the row count is preferably incremented at step 207. Execution then preferably resumes at step 203. If the current row is the last row in the array, execution proceeds to determine whether the threshold number of failures has been counted in the current column in step 210. If the threshold has not been met, the counter is reset in step 211. If the threshold has been met, a flag is set indicating that the current cache segment is faulty. This flag may appropriately be used later when deciding upon a repair strategy for the cache segment under test. After the flag is set in step 209, execution preferably resumes at step 208.

Preferably, at step 208, the inventive mechanism determines whether the current column is the last in the cache segment under test. If the current column is the last one in the cache segment, execution proceeds at step 213, if not, execution continues at step 212. If the “faulty cache segment” flag is set in step 213, the cache segment is repaired in step 214. If the “faulty cache segment” flag is not set when evaluated in step 213, execution concludes at step 215. Likewise, after repair cache segment step 214 is completed, execution concludes at step 215.

Preferably, at step 212, the row count is set to 0, and the column count is incremented. Once step 212 is complete, execution preferably resumes at step 203. In an alternative embodiment, once any column within a cache segment is found to have a threshold number of failures, the cache segment could be repaired substantially immediately thereafter, without testing any further columns in such cache segment.

Herein, “repair” of an array generally refers to the deployment of real estate, or space, on a silicon chip as an substitute for currently used space, when a cache region is found to be faulty. Preferably, such hardware substitution is implemented independently of any programs accessing the relocated cache segment so that such accessing programs need not be modified to accommodate the physical re-mapping of the cache segment.

Although the instant discussion is directed primarily toward an embodiment in which the total number of errors in one column are counted and this total used to determine whether an entire array should be repaired, it will be appreciated that error-counting could be conducted within other specific geometric patterns, such as rows, or within mathematically defined patterns, including non-geometric patterns, within an array, and the result employed to indicate the overall health of such array, and all such variations are included within the scope of the present invention.

FIG. 3 is a block diagram of hardware suitable for implementing a conditional reset mechanism according to a preferred embodiment of the present invention. The embodiment of FIG. 3 is suitable for operation with a single cache segment, such as cache segment 130. Generally, there would be one implementation of conditional reset mechanism 300 for each cache segment in an array. Failure counter 301 in FIG. 3 generally corresponds to counters 104 and 109 depicted in FIG. 1.

In a preferred embodiment, reset mechanism 300 has three inputs. Preferably, failure input 312 is normally low and transitions high when a failure condition is detected for a currently indicated element in a cache segment under test. Preferably, Last_Column input 308 is normally low and transitions high when the last column of a current cache segment is reached. Preferably, Last_Row input 307 is normally low and transitions high when the last row of the current cache segment is reached.

In a preferred embodiment, a threshold or maximum value for failure counter 301 may be set. Generally, when a number of faults occurring within a particular column, or occurring within another form of defined pattern within an array, reaches the threshold value, the cache segment as a whole which includes this column is considered faulty. In a preferred embodiment, this threshold may be set to a value of 3, however a value lower or higher than three may be selected, and all such variations are included within the scope of the present invention.

In a preferred embodiment, counter 301 has two inputs: increment signal 312 and reset signal 302. Preferably, when increment signal 312 is high, the counter increments. When reset signal 302 is high, counter 301 is preferably reset. Preferably, increment signal 312 transitions high and then low again before reset signal 302 transitions high in order to allow proper operation of circuit 300. This sequence of events preferably allows failure counter 301 to count a failure in the last row and column, if necessary, before being reset.

In a preferred embodiment, failure counter 301 has two outputs: OUT0 303, the most significant bit of the counter value and OUT1 304, the least significant bit of the counter value.

In a preferred embodiment, at the beginning of the test sequence of FIG. 2, counter 301 is initialized to 0, last_column 308 signal is 0 (false), and last_row 307 signal is 0 (false). As failures are detected in a current column, the counter will increment once for each failure detected. Preferably, after the last row in the current column is tested, “last_row” signal 308 will transition high.

Generally, if counter 301 has a value is 0, 1, or 2, counter 301 is not at its maximum value, and counter_max signal 310 will be high, allowing reset signal 302 to transition high. If counter 301 value is 3, counter_max signal 310 will be low, and reset signal 302 will be unable to transition high. In the latter case, counter_max signal 310 will remain low for the rest of the test process, and at the end of the process, the pertinent cache segment will be identified as one with a probable column failure.

FIG. 4 is a block diagram of hardware suitable for cache segment replacement according to a preferred embodiment of the present invention. The embodiment of FIG. 4 demonstrates a preferred approach to physically re-mapping cache segments after a cache repair configuration is determined. At the top of the FIG. 4 are six cache segments 130-131 and 401-404 and six column multiplexors 409-414. Preferably, column multiplexors 405-408 allow both reads and writes to be performed on cache segments 130-131 and 402-404.

Column redundancy multiplexors 405-408 are shown below column multiplexors 130-131 and 402-404 in the preferred embodiment of FIG. 4. The column redundancy multiplexors select which cache segments are visible to the cache Built-In Self-Test (BIST) hardware and the CPU core. The select inputs on the left of these multiplexors are driven by registers in the BIST hardware that describe the repair configuration.

In a preferred embodiment, in a default configuration, each column redundancy multiplexor uses its left-most input, giving BIST and the CPU access to cache segments 0-3, indicated by reference numerals 130, 131, 401, and 402, respectively. If any of these cache segments is found to have a hardware failure, the inputs to column redundancy multiplexors 405-408 are driven to shift their inputs to the right as necessary to bypass the failing segment. Redundancy multiplexors 405-408 can shift one or two segments to the right and therefore can accommodate two failing cache segments. Generally, if more than two segments fail, the cache may not be repaired.

The following table shows how the column redundancy multiplexors would preferably be configured for different failing cache segments. “L” refers to the left-most input on the column redundancy multiplexor, “M” to the middle input, and “R” to the right-most input.

| | Column Redundancy | | | | |
|---|---|---|---|---|---|
| Failed | multiplexor Number | | | | |
| segments | 0 | 1 | 2 | 3 | |
| None | L | L | L | L | |
| 1 (131) | L | M | M | M | (omits segment 131) |
| 1, 2 (131, 401) | L | R | R | R | (omits segments 131 and 401) |
| 1, 3 (131, 402) | L | M | R | R | (omits segments 131 and 402) |
| 3 (402) | L | L | L | M | (omits segment 402) |

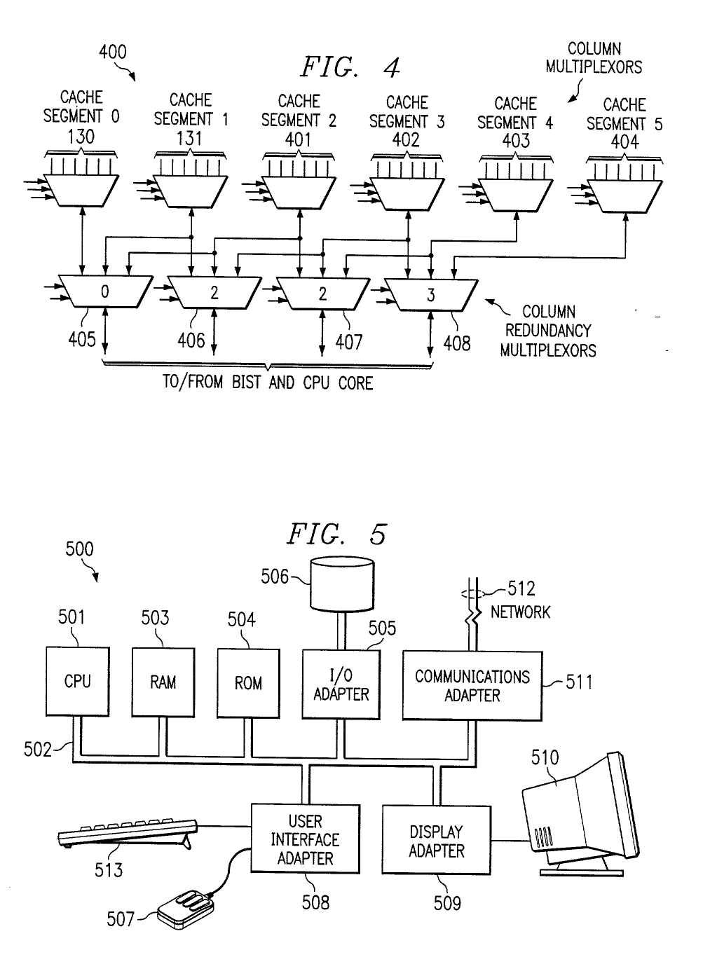

FIG. 5 illustrates computer system 500 adaptable for use with a preferred embodiment of the present invention. Central processing unit (CPU) 501 is coupled to system bus 502. CPU 501 may be any general purpose CPU, such as a Hewlett Packard PA-8200. However, the present invention is not restricted by the architecture of CPU 501 as long as CPU 501 supports the inventive operations as described herein. Bus 502 is coupled to random access memory (RAM) 503, which may be SRAM, DRAM, or SDRAM. ROM 504 is also coupled to bus 502, which may be PROM, EPROM, or EEPROM. RAM 503 and ROM 504 hold user and system data and programs as is well known in the art.

Referring to FIG. 5, Bus 502 is also coupled to input/output (I/O) adapter 505, communications adapter card 511, user interface adapter 508, and display adapter 509. I/O adapter 505 connects to storage devices 506, such as one or more of hard drive, CD drive, floppy disk drive, tape drive, to the computer system. Communications adapter 511 is adapted to couple the computer system 500 to a network 512, which may be one or more of local area network (LAN), wide-area network (WAN), Ethernet or Internet network. User interface adapter 508 couples user input devices, such as keyboard 513 and pointing device 507, to the computer system 500. Display adapter 509 is driven by CPU 501 to control the display on display device 510.

What is claimed is:

1. A method of evaluating a reliability of a memory segment, the method comprising the steps of:
counting malfunctioning elements in at least one instance of a defined geometric pattern of said memory segment;
declaring a fault condition within said memory segment if a number of said counted malfunctioning elements at least equals a fault threshold; and
re-mapping said memory segment in response to said declared fault condition.

2. The method of claim 1 wherein said step of counting malfunctioning elements comprises the step of:
counting malfunctioning elements in at least one column of said memory segment.

3. The method of claim 2 wherein said step of counting malfunctioning elements in at least one column of said memory segment comprises the step of:
counting malfunctioning elements in all columns of said memory segment.

4. The method of claim 1 wherein said step of counting malfunctioning elements in a defined geometric pattern comprises the step of:
counting malfunctioning elements in at least one row of said memory segment.

5. The method of claim 1 wherein said step of declaring said fault condition comprises the step of:
setting a flag indicating one of a pass condition and a fail condition for said memory segment.

6. The method of claim 5 further comprising the step of:
discarding a result of said counting step upon completing said step of setting said flag.

7. The method of claim 1 further comprising the step of:
avoiding recording a total number of said counted malfunctioning elements in said memory segment.

8. The method of claim 1 further comprising the steps of:
loading test data into said memory segment;
reading said loaded test data from said memory segment; and
comparing said read loaded test data to expected data for at least one element of said memory segment.

9. The method of claim 1 further comprising the step of:
determining said fault threshold based upon at least one characteristic of said memory segment.

10. The method of claim 1 further comprising the step of resetting a count of malfunctioning elements after said counting step.

11. A system for maintaining an operation of a memory segment, the system comprising:
means for evaluating elements of said memory segment in row-fast order;
means for identifying faulty ones of said evaluated elements;
means for generating a count of said identified faulty ones of said evaluated elements found for each column of said memory segment; and
means for establishing one of a pass condition and a failure condition for said memory segment based on a value of said count of said identified faulty ones of said evaluated elements.

12. The system of claim 11 further comprising:
means for preserving information about said generated count for only one column of said memory segment at a time.

13. The system of claim 11 further comprising:
means for resetting a count of said identified faulty ones of said evaluated elements upon initiating traversal of a new column.

14. The system of claim 11 wherein the means for establishing comprises:
means for comparing said generated count to a threshold value.

15. The system of claim 11 further comprising:
means for clearing one of said pass condition and said fail condition upon completing a traversal of said memory segment.

16. The system of claim 11 wherein said means for generating a count comprises:
means for incrementing a failure counter upon detecting one of said faulty ones of said evaluated elements.

17. The system of claim 11 further comprising:
means for physically re-mapping said memory segment upon establishment of said failure condition for said memory segment.

18. A method for preserving an operation of a memory segment, the method comprising the steps of:
evaluating elements of said memory segment in row-fast order;
identifying faulty ones of said evaluated elements;
determining a number of said identified faulty ones of said evaluated elements in each column of said memory segment;
comparing said determined number to a fault threshold value;
declaring a failure condition for said memory segment if said determined number is at least equal to said fault threshold value for any column of said memory segment; and
physically re-mapping said memory segment in response to said declared failure condition.

19. The method of claim 18 wherein said identifying step comprises the steps of:
storing evaluation data in said elements of said memory segment;
comparing said stored evaluation data to expected data for said elements of said memory segment; and
identifying elements for which said stored evaluation data does not match said expected data.

20. The method of claim 18 wherein said determining step comprises the step of:
incrementing a failure counter upon detection of a faulty element in said step of identifying.
